(19) United States
(12) Patent Application Publication
(10) Pub. No.: US 2026/0247424 A1
(43) Pub. Date: Aug. 20, 2026

(54) METHOD OF PROVIDING DYNAMIC LOW LATENCY TRANSMISSION FOR HIGH PRIORITY TRAFFIC AND RELATED COMMUNICATION SYSTEM

(71) Applicant: MEDIATEK INC., Hsinchu City (TW)

(72) Inventors: Han-Cheng Shih, Hsinchu City (TW); Bo-Yu Huang, Hsinchu City (TW); Yuan-Chin Wen, Hsinchu City (TW)

(73) Assignee: MEDIATEK INC., Hsinchu City (TW)

(21) Appl. No.: 19/450,769

(22) Filed: Jan. 16, 2026

Related U.S. Application Data
(60) Provisional application No. 63/758,387, filed on Feb. 14, 2025.

(51) Int. Cl. H04W 72/543; H04W 28/02; H04W 72/56

(52) U.S. Cl. CPC H04W 72/543; H04W 28/0268; H04W 72/56

(57) ABSTRACT

A method of providing dynamic low latency transmission for high priority traffic is provided. If a data packet currently scheduled for transmission is a high-priority packet, data transmission is performed in the low-latency mode for reducing environmental interference and increasing successful transmission rate. If a data packet currently scheduled for transmission is not a high-priority packet, data transmission is performed in the normal mode for achieving best-performance advantage.

### CROSS REFERENCE TO RELATED APPLICATIONS

This application claims the benefit of U.S. Provisional Application No. 63/758,387, filed on February 14th, 2025. The content of the application is incorporated herein by reference.

### BACKGROUND

Wireless communication systems are being widely deployed to provide various types of communication services such as voice and data. In general, a wireless communication system is a multiple access system capable of supporting communication with multiple users by sharing available system resources (such as bandwidth and transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system, and a multi carrier frequency division multiple access (MC-FDMA) system.

Multi-link operation (MLO) enables devices to send and receive data across links on different frequency bands. Connecting across multiple frequency bands can increase throughput, reduce latency, and improve reliability. Enhanced multi-link single-radio (eMLSR) is a type of MLO that enables a single-radio multi-link device to switch between links on different frequency bands to improve throughput and latency.

Enhanced distributed channel access (EDCA) is a Quality of Service (QOS) mechanism defined in the IEEE 802.11 family of standards for wireless local area network (WLAN) technology, wherein relatively higher priority traffic has a higher chance of being transmitted than relatively lower priority traffic. To facilitate this outcome, EDCA assigns frames/packets to access categories corresponding to levels of priority. Such access categories may include, in order of increasing priority: background information access category (AC_BK), best effort access category (AC_BE), video access category (AC_VI) and voice access category (AC_VO).

Each access category defines different time intervals for contention window-related parameters such as arbitration inter-frame space (AIFs) and contention window (CW). To ensure that relatively higher priority traffic has a higher chance of being transmitted than relatively lower priority traffic, contention window-related parameters for the higher priority access categories generally define shorter time intervals than corresponding contention window-related parameters for relatively lower priority access categories. With these shorter time intervals, the relatively higher priority traffic is more likely to win contention than the relatively lower priority traffic.

However, granting relatively higher priority traffic a higher chance of being transmitted does not necessarily ensures a higher chance of successful transmission. Environmental interference may cause transmission collisions and numerous retries, leading to increased latency. Therefore, there is a need for a method of dynamic low latency transmission for high priority traffic.

### SUMMARY

The present disclosure provides a method of providing dynamic low latency transmission for high priority traffic. The method includes: receiving, by a communication system, data packets of a plurality of application flows; and transmitting, by the communication system, the data packets in a low-latency mode when determining that a first data packet currently scheduled for transmission is a high-priority packet, wherein the low-latency mode prioritizes response time for a network connection.

The present disclosure also provides a communication system which includes at least one machine-readable storage medium and a processor circuitry. The at least one machine-readable storage medium stores program instructions. The processor circuitry is coupled to the at least one machine-readable storage medium and configured to execute the program instructions to: receive data packets of a plurality of application flows, and transmit the data packets in a low-latency mode within a guard time when determining that a first data packet currently scheduled for transmission is a high-priority packet, wherein the low-latency mode prioritizes response time for a network connection.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a communication system which provides dynamic low latency transmission for high priority traffic according to an embodiment of the present disclosure.

FIG. 2 is a flow chart illustrating a method of providing dynamic low latency transmission for high priority traffic according to an embodiment of the present disclosure.

FIG. 3 is a diagram illustrating a computer system that may be used to implement a method of providing dynamic low latency transmission for high priority traffic according to an embodiment of the present disclosure.

### DETAILED DESCRIPTION

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment” “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The term “connected” may mean that two or more elements, at a common communication protocol layer, have an established signaling relationship with one another over a communication channel, link, interface, or reference point.

The term “radio frequency (RF) signal” as used herein comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

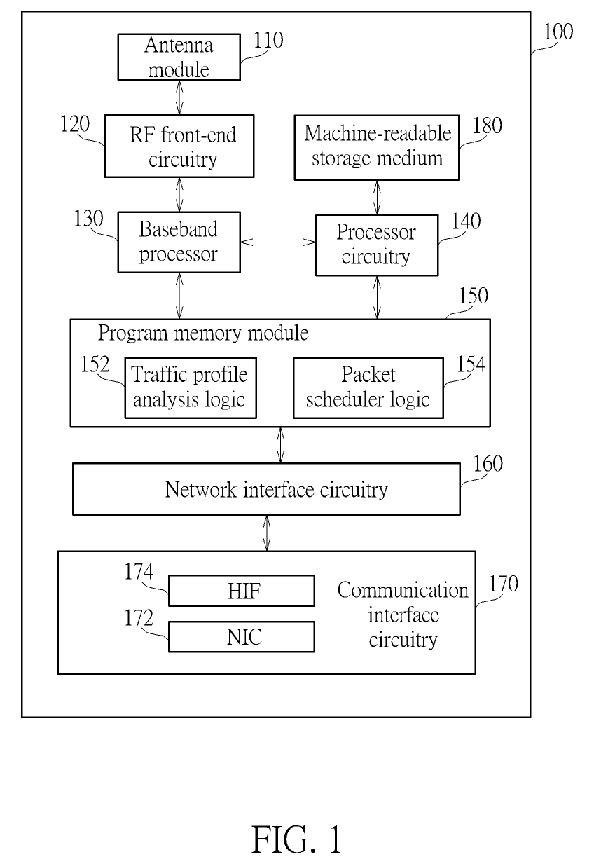

FIG. 1 is a block diagram illustrating a communication system 100 which provides dynamic low latency transmission for high priority traffic according to an embodiment of the present disclosure. As shown, the communication system 100 includes an antenna module 110, an RF front-end circuitry 120, a baseband processor 130, a processor circuitry 140, a program memory module 150, a network interface circuitry 160, a communication interface circuitry 170 and at least one machine-readable storage medium 180.

In various embodiments, the communication system 100 may be a smart phone, tablet, laptop, personal digital assistant (PDA), mobile computing device, navigation system, automated vehicle control system (ADAS), mobile data gathering platform, IoT devices, computer systems or any UE capable of providing data traffic prioritization and scheduling functions. However, the type of the communication system 100 does not limit the scope of the present disclosure.

The antenna module 110 is configured to facilitate the transmission and reception of electromagnetic waves within the RF spectrum across a myriad of devices and applications. As an example and not by way of limitation, the antenna module 110 may include one or more RF antennas configured to detect and transceive signals from radio access technologies (RATs) in the service area or venue with which the communication system 100 is associated. For example, long term evolution (including LTE, LTE-A, LTE-U and LTE-LAA) signals may be used as the basis of communication between the communication system 100 and various mobile devices. The one or more RF antennas may include multiple spatially diverse individual elements in an MIMO-type or an MISO-type configuration, such that spatial diversity of the transceived signals can be utilized for increase in coverage area. Spatial multiplexing (SM) may also be utilized by the communication system 100 to enhance data throughput, such as by multiplexing data streams on different antennas of the antenna module 110. However, the implementation of the antenna module 110 does not limit the scope of the present disclosure.

The RF front-end circuitry 120 is configured to handle the transmission and reception of RF signals via the antenna module 110. As an example and not by way of limitation, the RF front-end circuitry 120 may include one or more filters, duplexers, low noise amplifiers (LNA), power amplifiers (PA), frequency converters, phase shifters, attenuators and switches. The filters are used to isolate and separate signals within specific frequency ranges, ensuring that the desired frequency band is transmitted or received. The duplexers allow the use of a single antenna for transmission and reception using the same frequency band. The LNAs amplify weak incoming RF signals from the antenna module 110 while adding minimal noise to the RF signals. The power amplifiers amplify the RF signals before transmission. The frequency converters use RF mixers to convert intermediate frequency signals to RF signals and vice versa. The phase shifters adjust the phase of a signal in real-time and control the direction of the transmitted or received signal when used in beam-forming and phased array antenna systems. The attenuators control signal strength by introducing a controlled amount of signal loss. The switches route signals between different components. However, the implementation of the RF front-end circuitry 120 does not limit the scope of the present disclosure.

The baseband processor 130 is configured to handle digital signal processing (DSP), signal modulation/demodulation, error correction, and conversion of the RF signals into a format that can be understood by the end-user or device. As an example and not by way of limitation, the baseband processor 130 may be a type of microprocessor implemented with baseband signal processing and radio control functions, including in one variant physical layer (PHY) and Layer 2 functions such as media access control (MAC). The PHY layer performs coding and decoding, modulation and demodulation, antenna mapping and de-mapping, and resource mapping and de-mapping. The MAC layer performs priority control of data, retransmission processing through hybrid automatic repeat request (HARQ), a random access procedure, and the like. However, the implementation of the baseband processor 130 does not limit the scope of the present disclosure.

The processor circuitry 140 is configured to execute at least one computer program/firmware and/or control hardware components so as to perform various functions such as communication with relevant functional modules. As an example and not by way of limitation, the processor circuitry 140 may include one or more of a central processing unit (CPU), a digital signal processor, semiconductor-based microprocessor, field-programmable gate array (FPGA), graphics processing unit (GPU) or plurality of processing components mounted on one or more substrates and suitable for retrieval and execution of instructions stored in the machine-readable storage medium 180 to control processes or operations for traffic flow schedule prioritization/optimization. As an alternative or in addition to retrieving and executing instructions, the processor circuitry 140 may include one or more electronic circuits that include electronic components for performing the functionality of one or more instructions, such as a FPGA, application specific integrated circuit (ASIC), or other electronic circuits. However, the implementation of the processor circuitry 140 does not limit the scope of the present disclosure.

The program memory module 150 may implement one or more of direct memory access (DMA) type hardware, so as to facilitate data accesses associated with the communication system 100. As an example and not by way of limitation, the program memory module 150 may contain one or more computer-executable instructions that are executable by the processor circuitry 140. In the embodiment depicted in FIG. 1, the program memory module 150 includes traffic profile analysis logic 152 and a packet scheduler 154. The traffic profile analysis logic 152 includes a variety of functions including receipt and assembly of configuration and traffic profile (TP) data relating to the communication system 100, which includes customer premises equipment (CPE) ID, default bearer ID, number of network users served, traffic type data for each user/client, and priority levels for each user/client. The traffic profile analysis logic 152 may process the assembly of configuration and TP data so as uniquely associates data (and generated scheduling) with each participating CPE. In some embodiments, the traffic profile analysis logic 152 may be configured to utilize additional markings or identifiers to certain packets, so as to associate them with a particular function or service flow established within the scheduler logic 154. The packet scheduler logic 154 is configured to perform scheduling operations based on the TP data obtained from traffic profile analysis logic 152. However, the implementation of the program memory module 150 does not limit the scope of the present disclosure.

The network interface circuitry 160 is configured to connect the communication system 100 to a network element. As an example and not by way of limitation, the network interface circuitry 160 may be any signal or data interface with a component or network including, without limitation, those of the FireWire, USB, Ethernet, MoCA, Coaxsys, RF tuner, LTE, Wi-Fi, WiMAX, Z-wave, PAN, or power line carrier (PLC) families. However, the implementation of the network interface circuitry 160 does not limit the scope of the present disclosure.

The communication interface circuitry 170 includes hardware, software, or both providing one or more interfaces for communication (such as, for example, packet-based communication) between the communication system 10 and one or more other electronic devices or one or more networks. In the embodiment depicted in FIG. 1, the communication interface circuitry 170 include a network interface controller (NIC) 172 and a host interface (HIF) 174.

As an example and not by way of limitation, the communication interface circuitry 170 may be configured to communicate with an Ethernet or other wire-based network or communicate with a wireless network (such as a WI-FI network) via the NIC 172. In an embodiment, via the NIC 172 of the communication interface circuitry 170, the communication system 100 may communicate with an ad hoc network, a personal area network (PAN), a local area network (LAN), a wide area network (WAN), a metropolitan area network (MAN), or one or more portions of the Internet or a combination of two or more of these, wherein one or more portions of one or more of these networks may be wired or wireless. In an embodiment, via the NIC 172 of the communication interface circuitry 170, the communication system 100 may communicate with a wireless PAN (WPAN), a Wi-Fi network, a Wi-MAX network, a cellular telephone network, or other suitable wireless network or a combination of two or more of these. The communication system 100 may include any suitable communication interface circuitry 170 for any of these networks, where appropriate. The communication interface circuitry 170 may include one or more communication interfaces, where appropriate. Although this disclosure describes and illustrates a particular communication interface, this disclosure contemplates any suitable communication interface.

The HIF 174 defines the standard set of kernel services that interface a user-application program to a host operating system. As an example and not by way of limitation, the HIF 174 may be implemented in each simulator, hardware vehicle, and high-level language in its own way. The kernel services provide the minimum functionality needed to interface high-level language library functions to the user’s operating system code.

The machine-readable storage medium 180 is configured to store one or more program instructions. As an example and not by way of limitation, the machine-readable storage medium 180 may include any type of integrated circuit or other storage device adapted for storing digital data including computer hard drives, DVR device, random access memory (RAM), non-volatile RAM (NVRAM), electrically erasable programmable read-only memory (EEPROM), RAID devices or arrays, optical media, or any other devices or media capable of storing executable instructions, content or other information. However, the implementation of the machine-readable storage medium 180 does not limit the scope of the present disclosure.

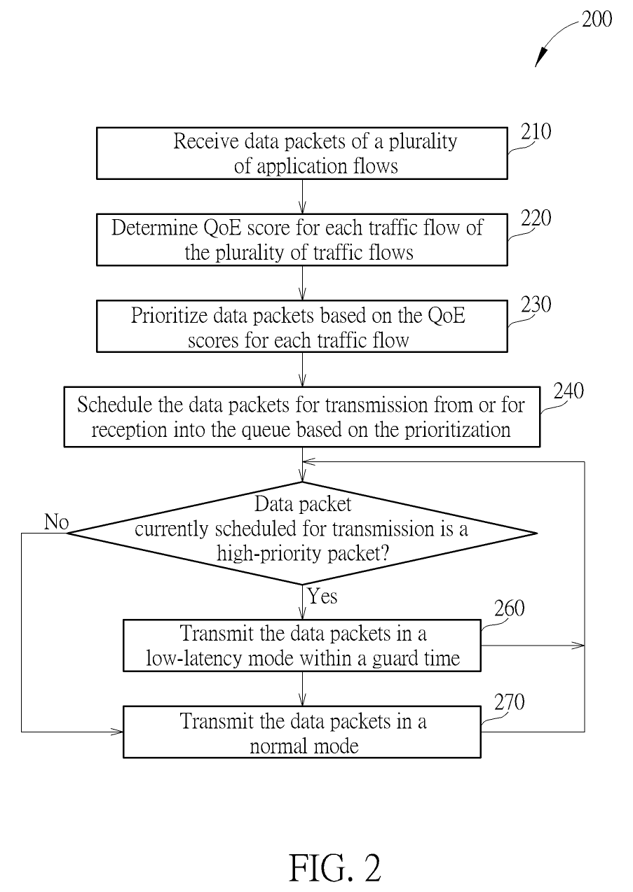

FIG. 2 is a flow chart illustrating a method of providing dynamic low latency transmission for high priority traffic according to an embodiment of the present disclosure. The method 200 depicted in FIG. 2 may be executed by the communication system 100 and includes the following steps:

Step 210: receive data packets of a plurality of application flows.

Step 220: determine a QoE score for each traffic flow of the plurality of traffic flows.

Step 230: prioritize the data packets based on the QoE scores for each traffic flow.

Step 240: schedule the data packets for transmission from or for reception into the queue based on the prioritization.

Step 250: determine whether a data packet currently scheduled for transmission is a high-priority packet; if yes, execute step 260; if no, execute step 270.

Step 260: transmit the data packets in a low-latency mode within a guard time; execute step 250.

Step 270: transmit the data packets in a normal mode; execute step 250.

In an embodiment, the program instructions associated with steps 210-270 may be stored in the machine-readable storage medium 180 of the communication system 100. The processor circuitry 140 may fetch and execute the program instructions associated with steps 210-270 to provide dynamic low latency transmission for high priority traffic.

At step 210, the processor circuitry 140 may execute the program instruction associated with step 210 for controlling the communication system 100 to receive data packets of the plurality of traffic flows via the communication interface circuitry 170.

At step 220, the processor circuitry 140 may execute the program instruction associated with step 220 to determine a QoE score for each traffic flow of the plurality of traffic flows. This way, the traffic flows having higher QoE scores have more opportunities to access a channel, so as to reduce delays of the low-delay services.

In an embodiment, the QoE score for each traffic flow of the plurality of traffic flows may be determined by the traffic profile analysis logic 152 based on QoS extensions defined in the IEEE 802.11 family of standards for wireless local area network (WLAN) technology. For example, QoS extensions for some 802.11 protocols may prioritize the transmission of voice packets and video packets. Particularly, Wi-Fi Multimedia (WMM), previously known as Wireless Multimedia Extensions (WME), is a subset of the 802.11e wireless LAN (WLAN) specification that enhances QoS on a network by prioritizing packets according to four access categories: voice access category (AC_VO), video access category (AC_VI), best effort access category (AC_BE), and background information access category (AC_BK). A QoS parameter (or referred to as an access channel configuration parameter) of each access category includes the following types: a maximum contention window (CWmax), a minimum contention window (CWmin), an arbitration interframe spacing number (AIFSN), and a transmission opportunity (TXOP) limit. By giving AC_VI and AC_VO packets higher priorities, WMM enables concurrent Voice over IP (VOIP) calls with minimal latency and the highest quality possible, as well as prioritizes it over all other data traffic and enables support for three to four standard definition TV (SDTV) streams or one high definition TV (HDTV) stream on a WLAN. AC_BE data packets consist of those originating from legacy devices or from applications or devices that lack QoS standards. AC_BK packets encompass file downloads, print jobs and other traffic that does not suffer from increased latency.

In an embodiment, the QoE score for each traffic flow of the plurality of traffic flows may be computed by the traffic profile analysis logic 152 based on at least one of: a jitter parameter of the traffic flow, a latency parameter of the traffic flow, a packet loss parameter of the traffic flow, a throughput parameter of the traffic flow, and an airtime parameter of the traffic flow.

At step 230, the processor circuitry 140 may execute the program instruction associated with step 230 to prioritize data packets based on the QoE score for each traffic flow, thereby providing a performance-oriented transmission scheme which maximizes the benefits for traffic to move efficiently in the wireless network. This way, the traffic flows having higher QoE scores, such as applications which require more treatment in terms of allocating wireless resources available from an access point, may have more opportunities to successfully preempt a channel in a shorter time.

At step 240, the processor circuitry 140 may execute the program instruction associated with step 240 to schedule the data packets for transmission from or for reception into the queue based on the prioritization. For example, the processor circuitry 140 may instruct the packet scheduler 154 to schedule the data packets for transmission from or for reception into the queue based on the prioritization acquired in step 230.

At step 250, the processor circuitry 140 may execute the program instruction associated with step 250 to determine whether a data packet currently scheduled for transmission is a high-priority packet. If it is determined in step 250 that the data packet currently scheduled for transmission is a high-priority packet, step 260 is executed for transmitting the data packets in the low-latency mode within a guard time. If it is determined in step 250 that the data packet currently scheduled for transmission is not a high-priority packet, step 270 is executed for transmitting the data packets in the normal mode. In the present disclosure, the low-latency mode prioritizes fast, real-time response times for network connections, while the normal mode prioritizes best network performance.

As previously stated, performance-oriented transmission schemes differentiate data priority through WMM queues, allowing high-priority data more opportunities to access a channel so as to reduce delays of the low-delay services. However, granting relatively higher priority traffic a higher chance of being transmitted does not necessarily ensures a higher chance of successful transmission. Environmental interference may cause transmission collisions and numerous retries, leading to increased latency, which may prevent the high priority advantage from being realized. Also, applications that are being developed for newer technology, such as virtual reality (VR) may require both high bandwidth and low latency guarantees in order to provide acceptable user experience.

In order to provide low latency transmission for high priority traffic, if it is determined in step 250 that a data packet currently scheduled for transmission is a high-priority packet (such as an AC_VO packet or an AC_VI packet), the processor circuitry 140 is configured to instruct the antenna module 110 to transmit high-priority packets in the low-latency mode in step 260 so as to reduce interference and the number of retransmissions as much as possible. As an example and not by way of limitation, the antenna module 110 may adopt a space-time block coding (STBC) transmission method, a lower transmission bandwidth, a lower quadrature amplitude modulation, (QAM) and/or a dual carrier modulation (DCM)/extended range (ER) rate in the low-latency mode. This way, high-priority packets may be transmitted in a timely manner for achieving low-latency advantage. After transmitting the data packets in the low-latency mode longer than the guard time in step 260, the present method loops back to step 250 for determining whether there are still high-priority packets scheduled for transmission.

If it is determined in step 250 that the data packet currently scheduled for transmission is not a high-priority packet, the processor circuitry 140 is configured to instruct the antenna module 110 to transmit the data packets in the normal mode in step 270 for achieving best-performance advantage.

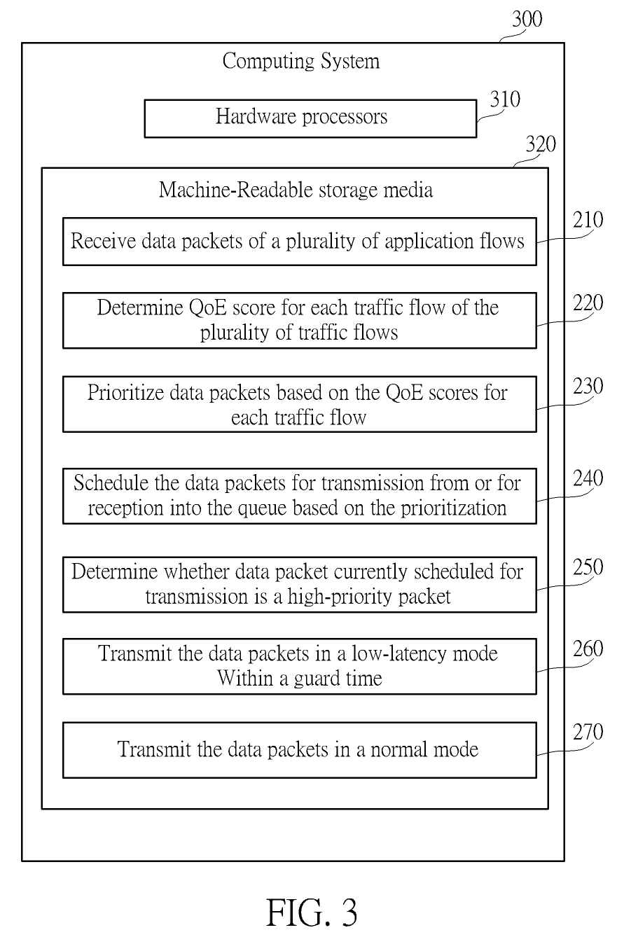

FIG. 3 is a diagram illustrating a computer system 300 that may be used to implement the method of providing dynamic low latency transmission for high priority traffic depicted in FIG. 2 according to an embodiment of the present application. As an example and not by way of limitation, the computer system 300 may be any type interconnected electronic devices, computer devices, or various components of a computer that are communicatively coupled with one another and configured to share computing or networking resources. In the example implementation of FIG. 3, the computer system 300 includes a hardware processor 310 and at least one machine-readable storage medium 320.

As an example and not by way of limitation, the hardware processor 310 may be one or more CPUs, semiconductor-based microprocessors, and/or other hardware devices suitable for retrieval and execution of program instructions stored in the machine-readable storage medium 320. Hardware processor 310 may fetch, decode, and execute program instructions, such as program instructions 210-270, to control processes or operations for traffic flow schedule optimization, thereby providing dynamic low latency transmission for high priority traffic. As an alternative or in addition to retrieving and executing instructions, hardware processor 310 may include one or more electronic circuits that include electronic components for performing the functionality of one or more program instructions, such as a field programmable gate array (FPGA), application specific integrated circuit (ASIC), or other electronic circuits. However, the implementation of the hardware processor 310 does not limit the scope of the present disclosure.

As an example and not by way of limitation, the machine-readable storage medium 320 may include any type of integrated circuit or other storage device adapted for storing digital data including computer hard drives, DVR device, RAM, NVRAM, EEPROM, RAID devices or arrays, optical media, or any other devices or media capable of storing executable instructions, content or other information. However, the implementation of the machine-readable storage medium 320 does not limit the scope of the present disclosure.

In conclusion, the present disclosure provides a method of providing dynamic low latency transmission for high priority traffic. If a data packet currently scheduled for transmission is a high-priority packet, data transmission is performed in the low-latency mode for reducing environmental interference and increasing successful transmission rate. If a data packet currently scheduled for transmission is not a high-priority packet, data transmission is performed in the normal mode for achieving best-performance advantage.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of providing dynamic low latency transmission for high priority traffic, comprising:
receiving, by a communication system, data packets of a plurality of application flows; and
transmitting, by the communication system, the data packets in a low-latency mode when determining that a first data packet currently scheduled for transmission is a high-priority packet, wherein the low-latency mode prioritizes response time for a network connection.

2. The method of claim 1, further comprising:
transmitting, by the communication system, the data packets in a normal mode when determining that the first data packet is not the high-priority packet, wherein the normal mode prioritizes best network performance.

3. The method of claim 1, further comprising:
determining, by the communication system, a quality of service (QoE) score for each traffic flow of the plurality of traffic flows based on an access category of each traffic flow defined in an IEEE 802.11 family of standard;
prioritizing, by the communication system, the data packets based on the QoE score for each traffic flow; and
scheduling, by the communication system, the data packets for transmission into a queue based on prioritization of the data packets.

4. The method of claim 3, wherein:
the high-priority packet is a voice access category (AC_VO) packet or a video access category (AC_VI) packet defined in the IEEE 802.11 family of standard.

5. The method of claim 1, further comprising:
determining, by the communication system, a QoE score for each traffic flow of the plurality of traffic flows by computing a jitter parameter, a latency parameter, a packet loss parameter, a throughput parameter, and/or an airtime parameter of each traffic flow;
prioritizing, by the communication system, the data packets based on the QoE score for each traffic flow; and
scheduling, by the communication system, the data packets for transmission into a queue based on prioritization of the data packets.

6. The method of claim 1, further comprising:
after transmitting the data packets in the low-latency mode for a guard time, determining, by the communication system, whether a second data packet currently scheduled for transmission is the high-priority packet; and
transmitting, by the communication system, the data packets in the normal mode when determining that the second data packet is not the high-priority packet.

7. The method of claim 1, further comprising:
transmitting, by the communication system, the data packets using a space-time block coding (STBC) transmission method, a lower transmission bandwidth, a low quadrature amplitude modulation, (QAM) and/or a dual carrier modulation (DCM)/extended range (ER) rate in the low-latency mode.

8. A communication system, comprising:
at least one machine-readable storage medium for storing program instructions; and
a processor circuitry coupled to the at least one machine-readable storage medium and configured to execute the program instructions to:
receive data packets of a plurality of application flows; and
transmit the data packets in a low-latency mode within a guard time when determining that a first data packet currently scheduled for transmission is a high-priority packet, wherein the low-latency mode prioritizes response time for a network connection.

9. The communication system of claim 8, wherein:
the processor circuitry is further configured to execute the program instructions to transmit the data packets in a normal mode when determining that the first data packet is not the high-priority packet; and
the normal mode prioritizes best network performance.

10. The communication system of claim 8, wherein the processor circuitry is further configured to execute the program instructions to:
determine a quality of service (QoE) score for each traffic flow of the plurality of traffic flows based on an access category of each traffic flow defined in an IEEE 802.11 family of standard;
prioritize the data packets based on the QoE score for each traffic flow; and
schedule the data packets for transmission into a queue based on prioritization of the data packets.

11. The communication system of claim 10, wherein:
the high-priority packet is a voice access category (AC_VO) packet or a video access category (AC_VI) packet defined in the IEEE 802.11 family of standard.

12. The communication system of claim 8, wherein the processor circuitry is further configured to execute the program instructions to:
determine a QoE score for each traffic flow of the plurality of traffic flows by computing a jitter parameter, a latency parameter, a packet loss parameter, a throughput parameter, and/or an airtime parameter of each traffic flow;
prioritize the data packets based on the QoE score for each traffic flow; and
schedule the data packets for transmission into a queue based on prioritization of the data packets.

13. The communication system of claim 8, wherein the processor circuitry is further configured to execute the program instructions to:
after transmitting the data packets in the low-latency mode for a guard time, determine whether a second data packet currently scheduled for transmission is the high-priority packet; and
transmit the data packets in the normal mode when determining that the second data packet is not the high-priority packet.

14. The communication system of claim 8, wherein the processor circuitry is further configured to execute the program instructions to:
transmit the data packets using a space-time block coding (STBC) transmission method, a lower transmission bandwidth, a low quadrature amplitude modulation, (QAM) and/or a dual carrier modulation (DCM)/extended range (ER) rate in the low-latency mode.
